(19) United States
(12) Patent Application Publication
(10) Pub. No.: US 2022/0205395 A1
(43) Pub. Date: Jun. 30, 2022

(54) FUEL GAS SUPPLY DEVICE AND METHOD

(71) Applicant: MITSUBISHI POWER, LTD., Yokohama-shi, Kanagawa (JP)

(72) Inventors: Yosuke Fujitomi, Kanagawa (JP); Tetsuya Igarashi, Kanagawa (JP); Yuusuke Kawasaki, Kanagawa (JP)

(73) Assignee: MITSUBISHI POWER, LTD., Yokohama-shi, Kanagawa (JP)

(21) Appl. No.: 17/609,895

(22) PCT Filed: Apr. 8, 2020
(86) PCT No.: PCT/JP2020/015832

§ 371 Date: Nov. 9, 2021

(30) Foreign Application Priority Data
May 13, 2019 (JP) 2019-090799

(51) Int. Cl. F02C 9/28; G05D 16/20; F02C 7/232

(52) U.S. Cl. CPC F02C 9/28; G05D 16/2013; F05D 2220/32; F05D 2240/35; F02C 7/232

(57) ABSTRACT

This fuel gas supply device and method comprises: a fuel gas supply line (L3) that connects a fuel gas supply source (100) and a combustor (12); a fuel gas compressor (24) that is provided to the fuel gas supply line (L3) and compresses fuel gas; a pressure detector (32) that detects a pressure (P2) of fuel gas which is introduced to the fuel gas compressor (24); and a pressure reducing valve (23) that is provided upstream from the fuel gas compressor (24) of the fuel gas supply line (L3) and that adjusts the pressure of the fuel gas so that a pressure (P1) of the fuel gas which is detected by the pressure detector (32) attains a certain target suction pressure consisting of a rated discharge pressure of the fuel gas compressor (24).

### TECHNICAL FIELD

The present invention relates to, for example, a fuel gas supply device and a method for supply of a fuel gas to a combustor of a gas turbine.

### BACKGROUND ART

A general gas turbine is composed of a compressor, a combustor, and a turbine. The compressor compresses air taken in through an air intake port to obtain high-temperature and high-pressure compressed air. The combustor obtains a high-temperature and high-pressure combustion gas by supplying fuel to the compressed air and performing combustion. The turbine is driven by the combustion gas and drives a coaxially connected generator.

In the gas turbine, a fuel gas of a predetermined pressure is supplied to the combustor. In this case, if the pressure of a fuel gas supplied from a gas company is substantially the same as the pressure of a fuel gas to be supplied to the combustor, it is not necessary to increase the pressure of the fuel gas. However, if the pressure of the fuel gas supplied from the gas company is lower than the pressure of the fuel gas to be supplied to the combustor, the fuel gas is supplied to the combustor after the pressure thereof is increased by a fuel gas compressor. Examples of such a fuel gas supply device include a fuel gas supply device described in PTL 1 below.

### CITATION LIST

### Patent Literature

[PTL 1] Japanese Patent No. 3993515

### SUMMARY OF INVENTION

### Technical Problem

As described above, the fuel gas supplied from the gas company is supplied to the combustor as it is if the pressure thereof is a predetermined pressure for supply to the combustor and the fuel gas is supplied to the combustor after the pressure thereof is increased by a gas compressor if the pressure thereof is lower than the predetermined pressure for supply to the combustor. However, although the gas compressor increases the pressure of a low-pressure fuel gas, there is an upper limit on a processable fuel gas suction pressure. That is, if a fuel gas of which the pressure exceeds the upper limit is introduced into the gas compressor, a large load is applied to the gas compressor, which may cause damage. If the gas compressor is damaged, there is a problem that the fuel gas cannot be supplied to the combustor, and a plant is stopped.

The present invention has been made to solve the above-described problem and an object thereof is to provide a fuel gas supply device and a method with which it is possible to suppress damage to a fuel gas compressor that increases the pressure of a fuel gas and to continuously supply a fuel gas of an appropriate pressure.

### Solution to Problem

In order to achieve the object described above, the present invention provides a fuel gas supply device including a fuel gas supply passage that connects a fuel gas supply source and a combustor to each other, a fuel gas compressor that is provided in the fuel gas supply passage and compresses a fuel gas, a first pressure detecting unit that detects a pressure of the fuel gas introduced into the fuel gas compressor, and a control valve that is provided upstream of the fuel gas compressor in the fuel gas supply passage and adjusts the pressure of the fuel gas such that the pressure of the fuel gas that is detected by the first pressure detecting unit reaches a certain target suction pressure, which is a rated discharge pressure of the fuel gas compressor.

Therefore, the fuel gas introduced into the fuel gas compressor is supplied to the fuel gas compressor after the pressure thereof is adjusted by the control valve such that the pressure reaches the certain target suction pressure, which is the rated discharge pressure of the fuel gas compressor. Then, the fuel gas compressor supplies the fuel gas to the combustor through the fuel gas supply passage after appropriately compressing the fuel gas to increase the pressure thereof to a predetermined pressure. As a result, damage to the fuel gas compressor that increases the pressure of the fuel gas can be suppressed and thus the fuel gas of an appropriate pressure can be continuously supplied to the combustor.

In the fuel gas supply device of the present invention, the control valve is a pressure-reducing valve.

Therefore, since the control valve is the pressure-reducing valve, it is possible to appropriately reduce the pressure of the fuel gas such that the pressure of the fuel gas reaches the certain target suction pressure, which is the rated discharge pressure of the fuel gas compressor.

In the fuel gas supply device of the present invention, a bypass passage of which one end portion is connected to the fuel gas supply passage that is upstream of the fuel gas compressor and the other end portion is connected to the fuel gas supply passage that is downstream of the fuel gas compressor such that the bypass passage bypasses the fuel gas compressor and a check valve that prevents backflow of the fuel gas in the bypass passage are provided and in a case where the pressure of the fuel gas that is detected by a second pressure detecting unit provided upstream of the control valve is equal to or higher than a pre-set upper limit pressure which is processable by the control valve, supply of the fuel gas to the fuel gas compressor is cut off, operation of the fuel gas compressor is stopped, and the fuel gas is caused to flow through the bypass passage.

Therefore, since supply of the fuel gas to the fuel gas compressor is cut off, the operation of the fuel gas compressor is stopped, and the fuel gas is caused to flow through the bypass passage in a case where the pressure of the fuel gas is equal to or higher than the upper limit pressure of the fuel gas compressor, it is possible to suppress damage to the fuel gas compressor caused by a high-pressure fuel gas and to continuously supply the fuel gas to the combustor.

In the fuel gas supply device of the present invention, the fuel gas is supplied to the fuel gas compressor and the fuel gas compressor is operated in a case where the pressure of the fuel gas that is detected by the second pressure detecting unit is lower than the upper limit pressure.

Therefore, since the fuel gas is supplied to the fuel gas compressor in a case where the pressure of the fuel gas is lower than the upper limit pressure of the fuel gas compressor, it is possible to supply the fuel gas to the combustor after the pressure thereof is increased to the predetermined pressure.

In the fuel gas supply device of the present invention, the control valve is disposed between a connecting portion and the fuel gas compressor, the connecting portion being between the fuel gas supply passage and the one end portion of the bypass passage.

Therefore, since the control valve is disposed between the connecting portion of the bypass passage and the fuel gas compressor, the distance between the control valve and the fuel gas compressor is made short and thus simplification in configuration and control can be achieved.

In the fuel gas supply device of the present invention, the control valve is disposed upstream of the connecting portion between the fuel gas supply passage and the one end portion of the bypass passage.

Therefore, since the control valve is disposed upstream of the connecting portion of the bypass passage, supply to the bypass passage is performed after the pressure of the fuel gas is adjusted to an appropriate pressure at an early stage and thus improvement in responsiveness can be achieved.

In the fuel gas supply device of the present invention, an isolation valve that prevents inflow of the fuel gas from a discharge port of the fuel gas compressor is provided between the fuel gas compressor in the fuel gas supply passage, the fuel gas supply passage, and the other end portion of the bypass passage.

Therefore, since the isolation valve that prevents inflow of the fuel gas from the discharge port of the fuel gas compressor is provided between the fuel gas compressor and a connecting portion of the bypass passage that is on a downstream side, a high-pressure fuel gas passing through the bypass passage is blocked by the isolation valve and thus the fuel gas does not flow back toward the fuel gas compressor so that damage to the fuel gas compressor can be suppressed.

The fuel gas supply device of the present invention further includes a control device that controls the control valve and the fuel gas compressor based on the pressure of the fuel gas that is detected by the first pressure detecting unit and the second pressure detecting unit.

Therefore, since the control device controls the control valve and the fuel gas compressor based on the pressure of the fuel gas, the pressure of the fuel gas supplied to the combustor can be automatically adjusted and thus improvement in workability can be achieved.

The fuel gas supply device of the present invention further includes a command device that issues a command to operate the fuel gas compressor based on the pressure of the fuel gas that is detected by the first pressure detecting unit and the second pressure detecting unit.

Therefore, since the command device issues a command to operate the fuel gas compressor based on the pressure of the fuel gas, an operator can easily operate the fuel gas compressor and automatic control becomes unnecessary, which results in cost reduction.

In addition, the present invention provides a fuel gas supply method for a fuel gas supply device including a fuel gas supply passage that connects a fuel gas supply source and a combustor to each other, a fuel gas compressor that compresses a fuel gas flowing through the fuel gas supply passage, and a control valve that is provided upstream of the fuel gas compressor in the fuel gas supply passage, the method including adjusting a pressure of the fuel gas by means of the control valve such that the pressure of the fuel gas to be introduced into the fuel gas compressor reaches a certain target suction pressure, which is a rated discharge pressure of the fuel gas compressor.

Therefore, it is possible to suppress damage to the fuel gas compressor caused by a high-pressure fuel gas and to continuously supply the fuel gas to the combustor.

### Advantageous Effects of Invention

With a fuel gas supply device and a method of the present invention, it is possible to suppress damage to a gas compressor that increases the pressure of a fuel gas and to continuously supply a fuel gas of an appropriate pressure.

### BRIEF DESCRIPTION OF DRAWINGS

FIG. 1 is a block configuration diagram showing a fuel gas supply device of a first embodiment.

FIG. 2 is a flowchart showing a fuel gas supply method.

FIG. 3 is a time chart showing control performed at the time of a switch from an operation state to a stopped state of a fuel gas compressor.

FIG. 4 is a time chart showing control performed at the time of a switch from the stopped state to the operation state of the fuel gas compressor.

FIG. 5 is a block configuration diagram showing a fuel gas supply device of a second embodiment.

FIG. 6 is a flowchart showing a fuel gas supply method.

FIG. 7 is a block configuration diagram showing a fuel gas supply device of a third embodiment.

FIG. 8 is a schematic view showing the entire configuration of a gas turbine.

### DESCRIPTION OF EMBODIMENTS

Hereinafter, preferred embodiments of the present invention will be described in detail based on the drawings. Note that the present invention is not limited by the embodiments, and in a case where there are a plurality of embodiments, the present invention encompasses combinations of the embodiments.

### First Embodiment

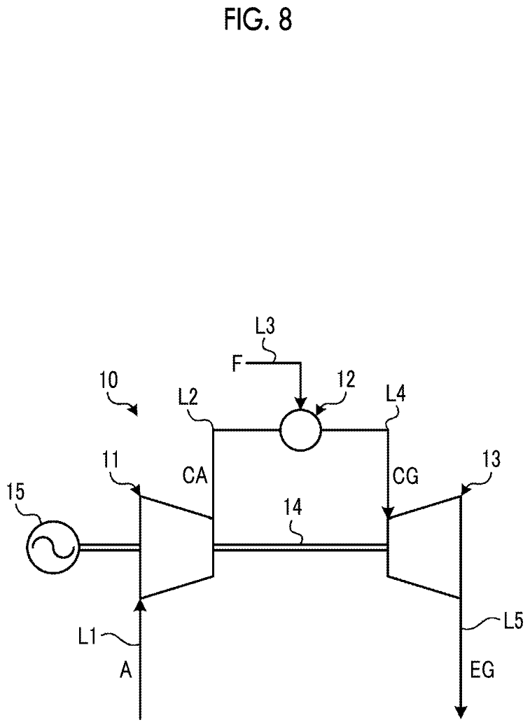

FIG. 8 is a schematic view showing the entire configuration of a gas turbine. In a first embodiment, a gas turbine 10 includes a compressor 11, a combustor 12, and a turbine 13 as shown in FIG. 8.

The compressor 11 and the turbine 13 are connected to each other by a rotary shaft 14 such that the compressor 11 and the turbine 13 can be integrally rotated and a generator 15 is connected to the rotary shaft 14. The compressor 11 compresses air A taken in from an air intake line L1. The combustor 12 mixes compressed air CA, which is supplied from the compressor 11 through a compressed air supply line L2, and fuel F supplied from a fuel gas supply line L3 with each other and performs combustion. The turbine 13 is rotationally driven by a combustion gas CG which is supplied from the combustor 12 through a combustion gas supply line L4. The generator 15 is driven by a rotational force transmitted due to rotation of the turbine 13. In addition, the turbine 13 is connected to an exhaust gas discharge line L5 through which an exhaust gas EG is discharged.

Therefore, when the gas turbine 10 is in operation, the compressor 11 compresses the air A, and the combustor 12 mixes the compressed air CA supplied thereto and the fuel F with each other and performs the combustion. The turbine 13 is rotationally driven by the combustion gas CG supplied from the combustor 12 and the generator 15 generates power. Then, the exhaust gas EG is discharged from the gas turbine 10 (turbine 13).

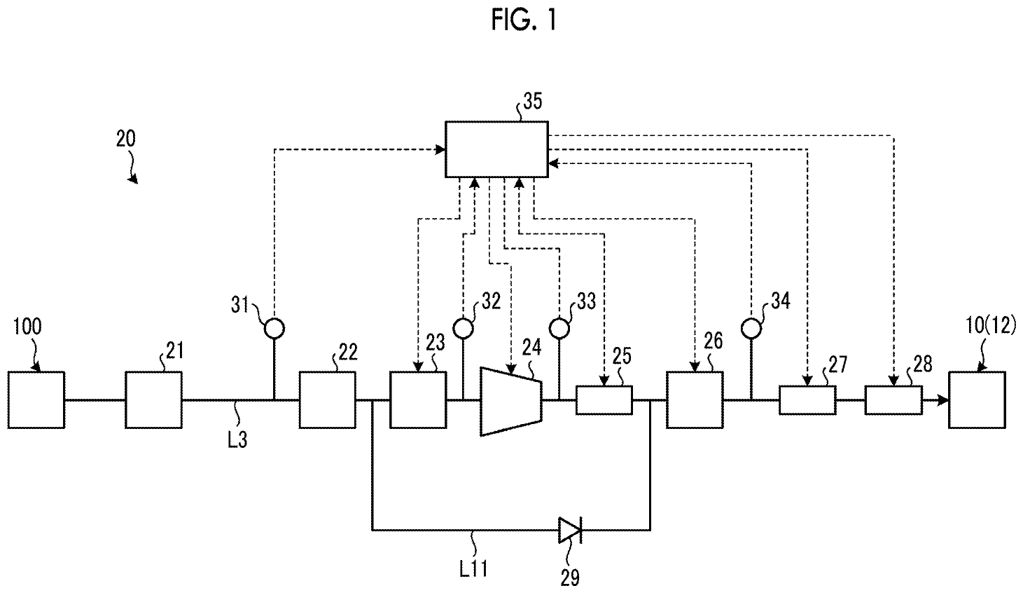

A fuel gas supply device of the first embodiment can compress the fuel F supplied from the fuel gas supply line L3 to the combustor 12 to increase the pressure thereof. FIG. 1 is a block configuration diagram showing the fuel gas supply device of the first embodiment.

In the first embodiment, as shown in FIG. 1, a fuel gas supply device 20 is provided in the fuel gas supply line L3, which is a fuel gas supply passage connecting a fuel gas supply source 100 and the combustor 12 of the gas turbine 10 to each other. In the fuel gas supply line L3 of the fuel gas supply device 20, a fuel gas pressure-reducing station 21, a fuel gas purification device 22, a pressure-reducing valve (control valve) 23, a fuel gas compressor 24, an isolation valve 25, a fuel gas heating device 26, a pressure regulation valve (PCV) 27, and a flow regulation valve (FCV) 28 are provided in this order from an upstream side in a fuel gas supply direction.

The fuel gas pressure-reducing station 21 reduces the pressure (for example, 3.7 MPa to 6.0 MPa) of a fuel gas supplied from the fuel gas supply source 100 to a predetermined pressure (for example, 3.7 MPa to 4.05 MPa) equal to or lower than the allowable pressure of a pipe. The fuel gas purification device 22 is a filter that removes foreign substances and the like contained in the fuel gas. The pressure-reducing valve 23 performs adjustment (pressure reduction) such that the fuel gas, of which the pressure has been decreased at the fuel gas pressure-reducing station 21, reaches a certain target suction pressure (for example, 3.0 MPa), which is the rated discharge pressure of the fuel gas compressor 24. Regarding the pressure-reducing valve 23, it is preferable that a pressure-reducing valve for a high flow rate and a pressure-reducing valve for a low flow rate, which are switchable in accordance with the flow rate of the fuel gas flowing therethrough, are arranged in parallel.

The fuel gas compressor 24 compresses the fuel gas to increase the pressure thereof to a predetermined pressure (for example, 4.5 MPa). The isolation valve 25 is provided downstream of the fuel gas compressor 24 to open and block the fuel gas supply line L3. The fuel gas heating device 26 heats the fuel gas until a predetermined temperature is reached. The pressure regulation valve 27 performs adjustment such that the fuel gas, of which the pressure has been increased by the fuel gas compressor 24, reaches an optimum pressure for supply to the combustor 12. The flow regulation valve 28 performs adjustment such that the fuel gas, of which the pressure has been adjusted by the pressure regulation valve 27, reaches an optimum amount for supply to the combustor 12.

In addition, the fuel gas supply device 20 includes a bypass line (bypass passage) L11 and a check valve 29.

The bypass line L11 is provided in parallel with the fuel gas supply line L3 to bypass the fuel gas compressor 24. An upstream side end portion (one end portion) of the bypass line L11 is connected to the fuel gas supply line L3 that is upstream of the pressure-reducing valve 23 and the fuel gas compressor 24 and a downstream side end portion (other end portion) is connected to the fuel gas supply line L3 that is downstream of the fuel gas compressor and the isolation valve 25. The check valve 29 prevents the backflow of the fuel gas and is provided in the bypass line L11.

In the first embodiment, the bypass line L11 is provided so as to bypass the pressure-reducing valve 23, the fuel gas compressor 24, and the isolation valve 25. In addition, the fuel gas compressor 24 is disposed between the pressure-reducing valve 23 and the isolation valve 25. Therefore, when the pressure-reducing valve 23 and the isolation valve 25 are opened, the fuel gas is introduced into the fuel gas compressor 24 and the fuel gas compressor 24 compresses the introduced fuel gas. Meanwhile, when the pressure-reducing valve 23 and the isolation valve 25 are closed, the introduction of the fuel gas into the fuel gas compressor 24 is cut off, so that the fuel gas flows to the bypass line L11 and is not compressed by the fuel gas compressor 24.

Furthermore, the fuel gas supply device 20 includes a pressure detector (second pressure detecting unit) 31, a pressure detector (first pressure detecting unit) 32, a pressure detector 33, a pressure detector 34, and a control device 35.

The pressure detector 31 is disposed between the fuel gas pressure-reducing station 21 and the fuel gas purification device 22 and detects a pressure P1 of the fuel gas to be introduced into the fuel gas compressor 24 through the pressure-reducing valve 23. The pressure detector 32 is disposed between the pressure-reducing valve 23 and the fuel gas compressor 24 and detects a pressure P2 of the fuel gas, of which the pressure has been decreased by the pressure-reducing valve 23 and is introduced into the fuel gas compressor 24. The pressure detector 33 is disposed between the fuel gas compressor 24 and the isolation valve 25 and detects a pressure P3 of the fuel gas compressed by the fuel gas compressor 24. The pressure detector 34 is disposed between the fuel gas heating device 26 and the pressure regulation valve 27 and detects a pressure P4 of the fuel gas before the pressure and the flow rate thereof are adjusted by the pressure regulation valve 27 and the flow regulation valve 28.

The results of detection performed by the pressure detector 31, the pressure detector 32, the pressure detector 33, and the pressure detector 34 are input to the control device 35. The control device 35 controls the pressure-reducing valve 23, the fuel gas compressor 24, the isolation valve 25, the fuel gas heating device 26, the pressure regulation valve 27, and the flow regulation valve 28 based on the results input thereto.

That is, the control device 35 opens the pressure-reducing valve 23 and the isolation valve 25, supplies the fuel gas to the pressure-reducing valve 23 and the fuel gas compressor 24, and operates the fuel gas compressor 24 in a case where the pressure of the fuel gas that is detected by the pressure detector 31 is lower than a pre-set upper limit pressure (for example, 4.05 MPa) which is processable by the pressure-reducing valve 23. Meanwhile, the control device 35 closes the pressure-reducing valve 23 and the isolation valve 25, cuts off supply of the fuel gas to the pressure-reducing valve 23 and the fuel gas compressor 24, and stops the operation of the fuel gas compressor 24 in a case where the pressure of the fuel gas that is detected by the pressure detector 31 is equal to or higher than the upper limit pressure (for example. 4.05 MPa). In this case, the fuel gas flows to the bypass line L11.

In addition, in a case where the fuel gas compressor 24 is operated, the control device 35 controls the pressure-reducing valve 23 such that the pressure of the fuel gas to be introduced into the fuel gas compressor 24 reaches the certain target suction pressure (for example, 3.0 MPa), which is the rated discharge pressure of the fuel gas compressor 24. Further, the control device 35 feedback-controls the pressure-reducing valve 23 based on the result of detection performed by the pressure detector 32. The control device 35 feedback-controls the fuel gas compressor based on the result of detection performed by the pressure detector 33. The control device 35 feedback-controls a change in pressure caused by a heating operation of the fuel gas heating device 26 based on the result of detection performed by the pressure detector 34.

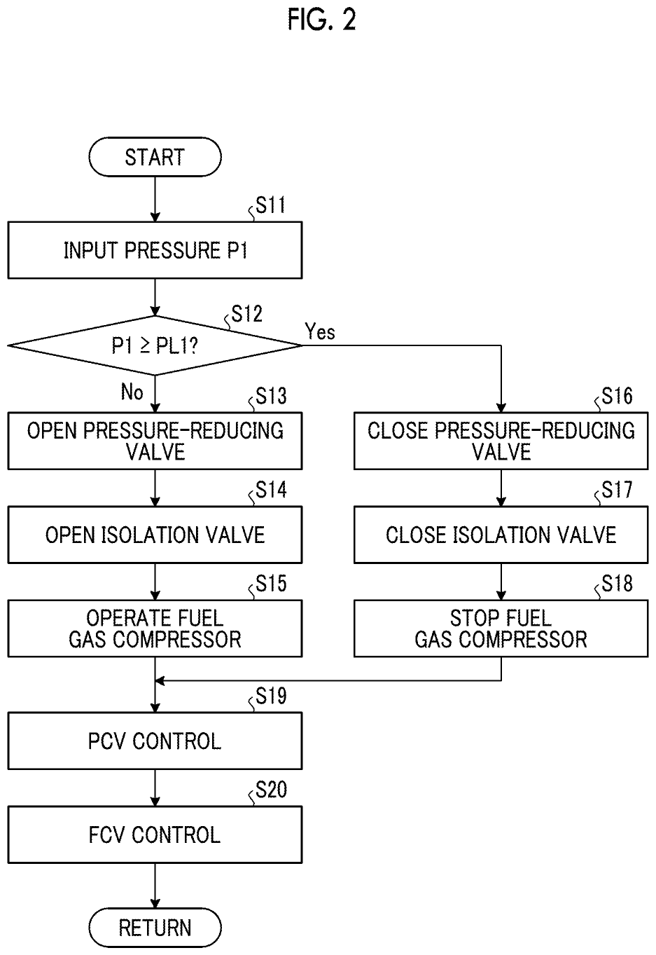

FIG. 2 is a flowchart showing a fuel gas supply method.

As shown in FIGS. 1 and 2, in step S11, the pressure P1 of the fuel gas that is detected by the pressure detector 31 is input to the control device 35. In step S12, the control device 35 determines whether or not the pressure P1 of the fuel gas that is detected by the pressure detector 31 is equal to or higher than an upper limit pressure PL1 (for example, 4.05 MPa) from which the pressure-reducing valve 23 can reduce the pressure to the suction pressure (for example, 3.0 MPa) which is processable by the fuel gas compressor 24. In a case where it is determined that the pressure P1 of the fuel gas is lower than the upper limit pressure PL1 (No), the control device 35 opens the pressure-reducing valve 23 in step S13, opens the isolation valve 25 in step S14, and operates the fuel gas compressor 24 in step S15. As a result, the pressure-reducing valve 23 reduces the pressure of the fuel gas, of which the pressure is, for example, 3.7 MPa to 4.05 MPa, down to 3.0 MPa and the fuel gas compressor 24 compresses the fuel gas, of which the pressure is, for example, 3.0 MPa, to increase the pressure thereof up to 4.5 MPa. At this time, since the check valve 29 is provided in the bypass line L11, the fuel gas of which the pressure is increased by the fuel gas compressor 24 does not flow back through the bypass line L11.

Meanwhile, in a case where it is determined that the pressure P1 of the fuel gas is equal to or higher than the upper limit pressure PL1 (Yes) in step S12, the control device 35 closes the pressure-reducing valve 23 in step S16, closes the isolation valve 25 in step S17, and stops the operation of the fuel gas compressor 24 in step S18. As a result, the fuel gas, of which the pressure is, for example, equal to or higher than 4.05 MPa, flows to the bypass line L11 and bypasses the pressure-reducing valve 23, the fuel gas compressor 24, and the isolation valve 25. At this time, since the isolation valve 25 is closed, the fuel gas of which the pressure is, for example, equal to or higher than 4.05 MPa, does not flow into the fuel gas compressor 24 by flowing back through the fuel gas supply line L3.

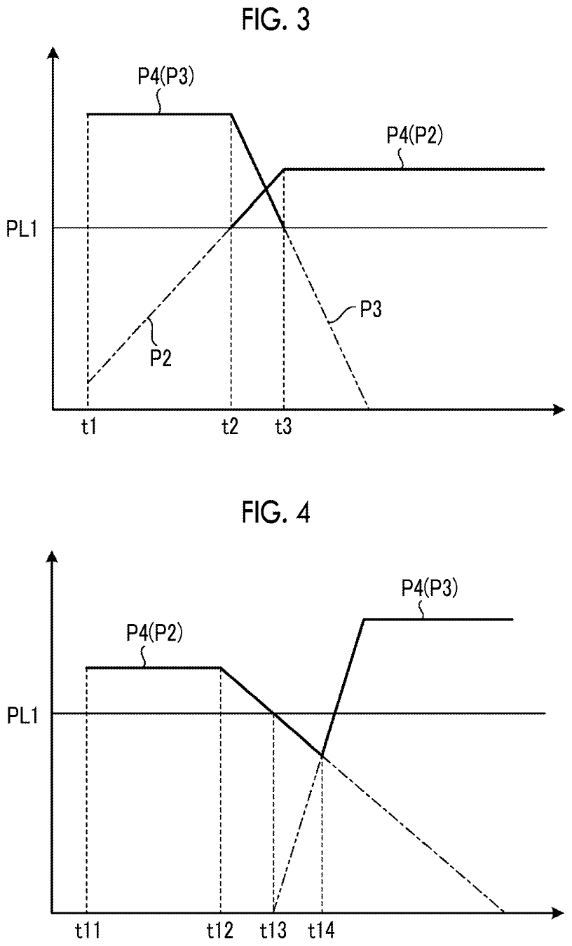

FIG. 3 is a time chart showing control performed at the time of a switch from an operation state to a stopped state of the fuel gas compressor and FIG. 4 is a time chart showing control performed at the time of a switch from the stopped state to the operation state of the fuel gas compressor.

As shown in FIGS. 1 and 3, in a case where the pressure P1 of a supplied fuel gas is lower than the upper limit pressure PL1 at a time t1, the pressure-reducing valve 23 and the isolation valve 25 are opened and the fuel gas compressor 24 compresses the fuel gas. Therefore, the pressure P4 of the fuel gas supplied to the combustor 12 is maintained at the pressure P3 (for example, 4.5 MPa), which is the discharge pressure of the fuel gas compressor 24. Here, in a case where the pressure P1 of the supplied fuel gas is increased and becomes equal to or higher than the upper limit pressure PL1 at a time t2, the operation of the fuel gas compressor 24 is stopped and the pressure-reducing valve 23 and the isolation valve 25 are closed with a delay. As a result, P3 of the fuel gas that is downstream of the fuel gas compressor 24 starts to be reduced at the time t2.

However, since the pressure P1 of the supplied fuel gas exceeds the upper limit pressure PL1, the pressure P4 of the fuel gas supplied to the combustor 12 is maintained at the pressure P1 of the supplied fuel gas, which is, for example, equal to or higher than 4.05 MPa, at a time t3.

As shown in FIGS. 1 and 4, in a case where the pressure P1 of the supplied fuel gas is equal to or higher than the upper limit pressure PL1 at a time t11, the pressure-reducing valve 23 and the isolation valve 25 are closed and the operation of the fuel gas compressor 24 is stopped. Therefore, the pressure P4 of the fuel gas supplied to the combustor 12 is maintained at the pressure P1 of the supplied fuel gas, which is, for example, equal to or higher than 4.05 MPa. In a case where the pressure P1 of the supplied fuel gas is decreased at a time 12 and becomes lower than the upper limit pressure PL1 at a time t13, the fuel gas compressor 24 is operated and the pressure-reducing valve 23 and the isolation valve 25 are opened. As a result, the pressure P3 of the fuel gas that is downstream of the fuel gas compressor 24 is increased although the pressure P1 of the supplied fuel gas is reduced and thus the pressure P4 of the fuel gas supplied to the combustor 12 is increased at a time t14 in a switching manner and is maintained at 4.5 MPa, for example.

A predetermined time is taken to increase the pressure P3 of the fuel gas to, for example, 4.5 MPa after the start of the operation of the fuel gas compressor 24 and thus there is a possibility that the pressure P4 of the fuel gas supplied to the combustor 12 becomes equal to or lower than a lower limit pressure. Therefore, the fuel gas compressor 24 may be configured to be operated when the pressure P1 of the fuel gas becomes lower than an upper limit pressure PL2 higher than the upper limit pressure PL1 instead of being configured to be operated when the pressure P1 of the fuel gas becomes lower than the upper limit pressure PL1. In addition, a time at which the operation of the fuel gas compressor 24 is started may be set based on a rate at which the pressure P1 of the fuel gas is reduced.

As described above, the fuel gas supply device of the first embodiment includes the fuel gas supply line L3 that connects the fuel gas supply source 100 and the combustor 12 to each other, the fuel gas compressor 24 that is provided in the fuel gas supply line L3 and compresses a fuel gas, the pressure detector 32 (pressure detector 31 that detects pressure P1 of fuel gas) that detects the pressure P2 of the fuel gas introduced into the fuel gas compressor 24, and the pressure-reducing valve 23 that is provided upstream of the fuel gas compressor 24 in the fuel gas supply line L3 and adjusts the pressure of the fuel gas such that the pressure P2 (pressure P1) of the fuel gas that is detected by the pressure detector 32 (pressure detector 31) reaches the certain target suction pressure, which is the rated discharge pressure of the fuel gas compressor 24.

Therefore, the fuel gas compressor 24 supplies the fuel gas to the combustor 12 through the fuel gas supply line L3 after appropriately compressing the fuel gas to increase the pressure thereof to a predetermined pressure. As a result, the fuel gas of an appropriate pressure can be continuously supplied to the combustor 12.

In the fuel gas supply device of the first embodiment, the pressure-reducing valve 23 is disposed upstream of the fuel gas compressor 24. Therefore, it is possible to appropriately reduce the pressure of the fuel gas such that the certain target suction pressure, which is the rated discharge pressure of the fuel gas compressor 24, is reached.

In the fuel gas supply device of the first embodiment, the bypass line L11 of which one end portion is connected to the fuel gas supply line L3 that is upstream of the fuel gas compressor 24 and the other end portion is connected to the fuel gas supply line L3 that is downstream of the fuel gas compressor 24 such that the bypass line L11 bypasses the fuel gas compressor 24 and the check valve 29 that prevents backflow of the fuel gas in the bypass line L11 are provided and in a case where the pressure P1 of the fuel gas that is detected by the pressure detector 31 is equal to or higher than the pre-set upper limit pressure PL1, from which the pressure-reducing valve 23 can reduce the pressure to the suction pressure (for example, 3.0 MPa) which is processable by the fuel gas compressor 24, supply of the fuel gas to the fuel gas compressor 24 is cut off, the operation of the fuel gas compressor 24 is stopped, and the fuel gas is caused to flow through the bypass line L11. Therefore, it is possible to suppress damage to the fuel gas compressor 24 caused by a high-pressure fuel gas, to continuously supply the fuel gas to the combustor 12, and save power for operation by stopping the operation of the fuel gas compressor 24.

In the fuel gas supply device of the first embodiment, the fuel gas is supplied to the fuel gas compressor 24 and the fuel gas compressor 24 is operated in a case where the pressure P1 of the fuel gas that is detected by the pressure detector 31 is lower than the upper limit pressure PL1. Therefore, it is possible to supply the fuel gas to the combustor 12 after the pressure thereof is increased to the predetermined pressure.

In the fuel gas supply device of the first embodiment, the pressure-reducing valve 23 is disposed between a connecting portion and the fuel gas compressor 24, the connecting portion being between the fuel gas supply line L3 and the one end portion of the bypass line L11. Therefore, the distance between the pressure-reducing valve 23 and the fuel gas compressor 24 is made short and thus simplification in configuration and control can be achieved.

In the fuel gas supply device of the first embodiment, the isolation valve 25 is provided between the fuel gas compressor 24 in the fuel gas supply line L3, the fuel gas supply line L3, and the other end portion of the bypass line L11. Therefore, a high-pressure fuel gas passing through the bypass line L11 is blocked by the isolation valve 25 and thus the high-pressure fuel gas does not flow back toward the fuel gas compressor 24. Accordingly, damage to the fuel gas compressor 24 can be suppressed.

In the fuel gas supply device of the first embodiment, the control device 35 that controls the pressure-reducing valve 23 and the fuel gas compressor 24 based on the pressures P1 and P2 of the fuel gas that are detected by the pressure detector 31 and the pressure detector 32 is provided. Therefore, the pressure of the fuel gas supplied to the combustor 12 can be automatically adjusted and thus improvement in workability can be achieved.

In addition, in the fuel gas supply method of the first embodiment, the pressure of the fuel gas is adjusted by means of the pressure-reducing valve 23 such that the pressure of the fuel gas to be introduced into the fuel gas compressor 24 reaches the certain target suction pressure, which is the rated discharge pressure of the fuel gas compressor 24. Therefore, the fuel gas compressor 24 supplies the fuel gas to the combustor 12 through the fuel gas supply line L3 after appropriately compressing the fuel gas to increase the pressure thereof to the rated discharge pressure. As a result, damage to the fuel gas compressor that increases the pressure of the fuel gas can be suppressed and thus the fuel gas of an appropriate pressure can be continuously supplied to the combustor 12.

### Second Embodiment

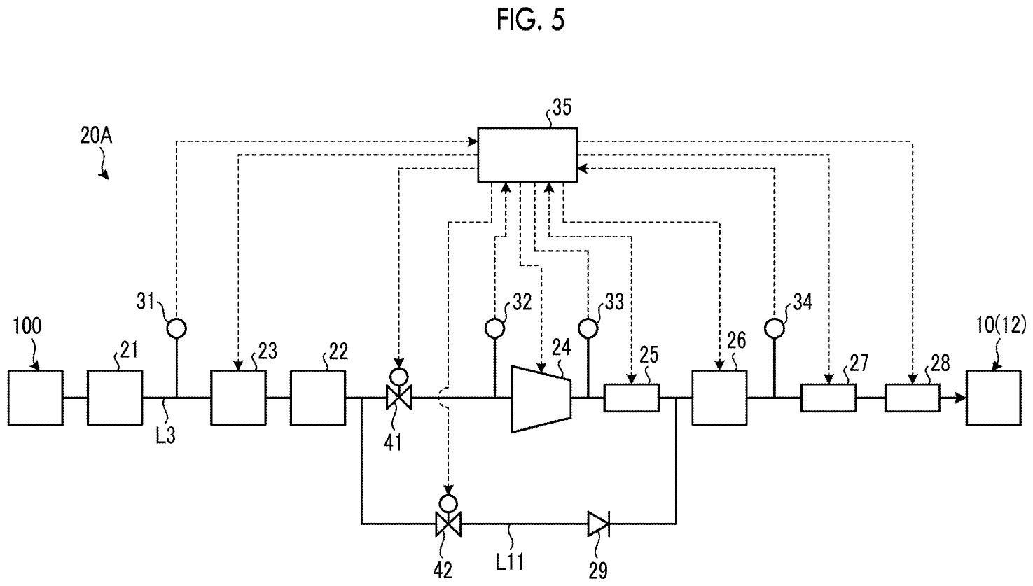

FIG. 5 is a block configuration diagram showing a fuel gas supply device of a second embodiment. Note that members having the same functions as those in the first embodiment will be given the same reference numerals, and detailed description thereof will be omitted.

As shown in FIG. 5, in the fuel gas supply line L3 of a fuel gas supply device 20A of the second embodiment, the fuel gas pressure-reducing station 21, the pressure-reducing valve (control valve) 23, the fuel gas purification device 22, a first opening-closing valve 41, the fuel gas compressor 24, the isolation valve 25, the fuel gas heating device 26, the pressure regulation valve (PCV) 27, and the flow regulation valve (FCV) 28 are provided in this order from an upstream side in a fuel gas supply direction.

In addition, the fuel gas supply device 20A includes the bypass line (bypass passage) L11, a second opening-closing valve 42, and the check valve 29.

In the second embodiment, the pressure-reducing valve 23 is disposed upstream of the connecting portion between the fuel gas supply line L3 and the one end portion of the bypass line L11. The bypass line L11 is provided so as to bypass the first opening-closing valve 41, the fuel gas compressor 24, and the isolation valve 25. In addition, the fuel gas compressor 24 is disposed between the first opening-closing valve 41 and the isolation valve 25. Meanwhile, the second opening-closing valve 42 is provided in the bypass line L11. Therefore, when the first opening-closing valve 41 and the isolation valve 25 are opened and the second opening-closing valve is closed, the fuel gas is introduced into the fuel gas compressor 24 and the fuel gas compressor 24 compresses the introduced fuel gas. Meanwhile, when the first opening-closing valve 41 and the isolation valve 25 are closed and the second opening-closing valve 42 is opened, the introduction of the fuel gas into the fuel gas compressor 24 is cut off so that the fuel gas flows to the bypass line L11 and is not compressed by the fuel gas compressor 24.

Furthermore, the fuel gas supply device 20A includes the pressure detector 31, the pressure detector 32, the pressure detector 33, the pressure detector 34, and the control device 35.

The pressure detector 31 is disposed between the fuel gas pressure-reducing station 21 and the pressure-reducing valve 23 and detects the pressure P1 of the fuel gas to be introduced into the fuel gas compressor 24 through the pressure-reducing valve 23 and the fuel gas purification device 22. The control device 35 opens the pressure-reducing valve 23 and the isolation valve 25, supplies the fuel gas to the pressure-reducing valve 23 and the fuel gas compressor 24, and operates the fuel gas compressor 24 in a case where the pressure of the fuel gas that is detected by the pressure detector 31 is lower than the pre-set upper limit pressure (for example, 4.05 MPa), from which the pressure-reducing valve 23 can reduce the pressure to the suction pressure (for example, 3.0 MPa) which is processable by the fuel gas compressor 24. Meanwhile, the control device 35 opens the pressure-reducing valve 23, closes the first opening-closing valve 41 and the isolation valve 25, and opens the second opening-closing valve to cut off supply of the fuel gas to the pressure-reducing valve 23 and the fuel gas compressor 24 and stops the operation of the fuel gas compressor 24 in a case where the pressure of the fuel gas that is detected by the pressure detector 31 is equal to or higher than the upper limit pressure (for example. 4.05 MPa). In this case, the fuel gas flows to the bypass line L11.

In addition, in a case where the fuel gas compressor 24 is operated, the control device 35 controls the pressure-reducing valve 23 such that the pressure of the fuel gas to be introduced into the fuel gas compressor 24 reaches the certain target suction pressure (for example, 3.0 MPa), which is the rated discharge pressure of the fuel gas compressor 24.

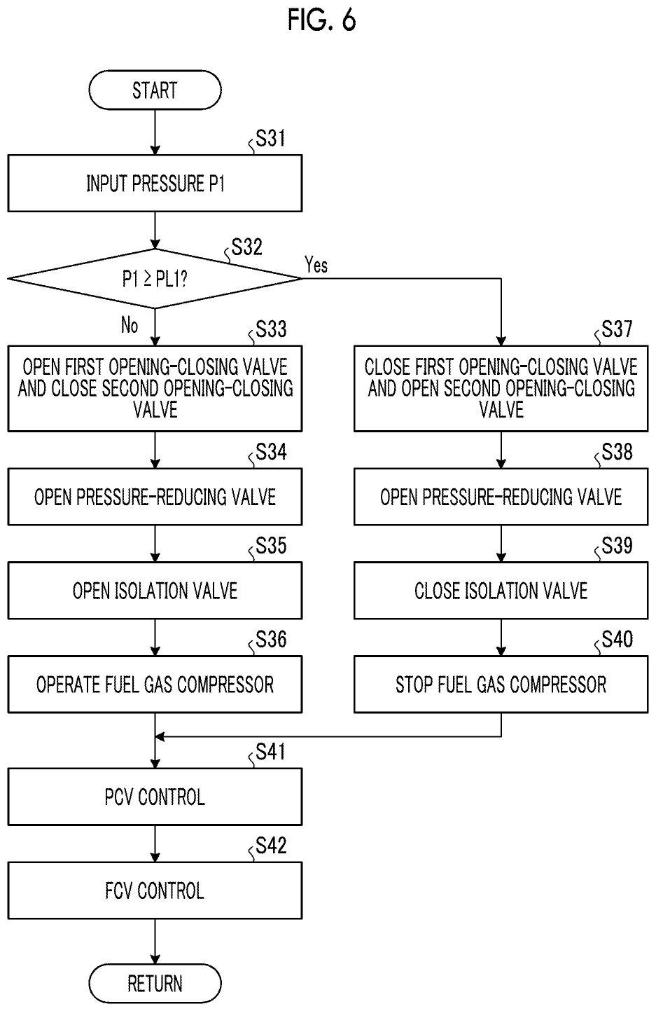

FIG. 6 is a flowchart showing a fuel gas supply method.

As shown in FIGS. 5 and 6, in step S31, the pressure P1 of the fuel gas that is detected by the pressure detector 31 is input to the control device 35. In step S32, the control device 35 determines whether or not the pressure P1 of the fuel gas that is detected by the pressure detector 31 is equal to or higher than the upper limit pressure PL1 (for example, 4.05 MPa) from which the pressure-reducing valve 23 can reduce the pressure to the suction pressure (for example, 3.0 MPa) which is processable by the fuel gas compressor 24. In a case where it is determined that the pressure P1 of the fuel gas is lower than the upper limit pressure PL1 (No), the control device 35 opens the first opening-closing valve 41 and closes the second opening-closing valve 42 in step S33. Then, the pressure-reducing valve 23 is opened in step S34, the isolation valve 25 is opened in step S35, and the fuel gas compressor 24 is operated in step S36. As a result, the pressure-reducing valve 23 reduces the pressure of the fuel gas, of which the pressure is, for example, 3.7 MPa to 4.05 MPa, down to 3.0 MPa and the fuel gas compressor 24 compresses the fuel gas, of which the pressure is, for example, 3.0 MPa, to increase the pressure thereof up to 4.5 MPa. At this time, since the second opening-closing valve 42 of the bypass line L11 is closed, the fuel gas does not flow through the bypass line L11.

Meanwhile, in a case where it is determined that the pressure P1 of the fuel gas is equal to or higher than the upper limit pressure PL1 (Yes) in step S32, the control device 35 closes the first opening-closing valve 41 and opens the second opening-closing valve 42 in step S37. Then, the pressure-reducing valve 23 is opened in step S38, the isolation valve 25 is closed in step S39, and the operation of the fuel gas compressor 24 is stopped in step S40. As a result, the fuel gas, of which the pressure is, for example, equal to or higher than 4.05 MPa, flows to the bypass line L11 and bypasses the first opening-closing valve, the fuel gas compressor 24, and the isolation valve 25. At this time, since the first opening-closing valve 41 and the isolation valve 25 are closed, the fuel gas does not flow into the fuel gas compressor 24.

As described above, in the fuel gas supply device of the second embodiment, the pressure-reducing valve 23 is disposed upstream of the connecting portion between the fuel gas supply line L3 and the one end portion of the bypass line L11. Therefore, the pressure of the fuel gas can be adjusted to an appropriate pressure at an early stage and thus improvement in responsiveness can be achieved.

### Third Embodiment

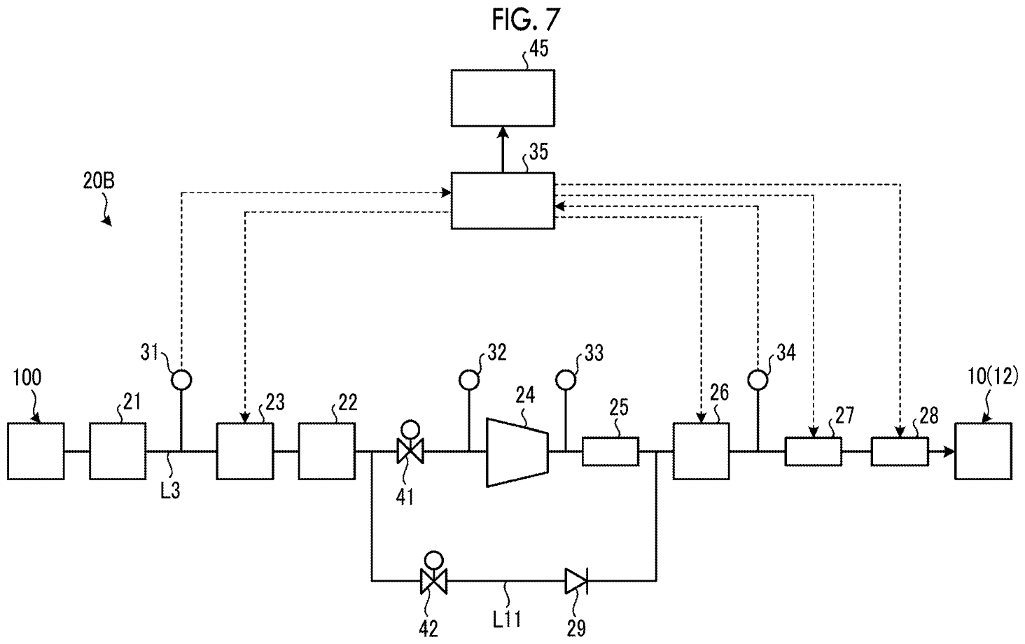

FIG. 7 is a block configuration diagram showing a fuel gas supply device of a third embodiment. Note that members having the same functions as those in the first embodiment will be given the same reference numerals, and detailed description thereof will be omitted.

As shown in FIG. 7, in the fuel gas supply line L3 of a fuel gas supply device 20B of the third embodiment, the fuel gas pressure-reducing station 21, the pressure-reducing valve (control valve) 23, the fuel gas purification device 22, the first opening-closing valve 41, the fuel gas compressor 24, the isolation valve 25, the fuel gas heating device 26, the pressure regulation valve (PCV) 27, and the flow regulation valve (FCV) 28 are provided in this order from an upstream side in a fuel gas supply direction. In addition, the fuel gas supply device 20B includes the bypass line (bypass passage) L11, the second opening-closing valve 42, and the check valve 29.

In addition, the fuel gas supply device 20B includes the pressure detector 31, the pressure detector 32, the pressure detector 33, the pressure detector 34, and the control device 35.

Furthermore, the fuel gas supply device 20B is provided with a command device 45 that issues a command to operate the fuel gas compressor based on the pressure of the fuel gas that is detected by the pressure detector 31.

In the third embodiment, the control device 35 controls the pressure-reducing valve 23 such that the pressure of the fuel gas to be introduced into the fuel gas compressor 24 reaches the certain target suction pressure (for example, 3.0 MPa), which is the rated discharge pressure of the fuel gas compressor 24. However, the control device 35 does not control the fuel gas compressor 24, the first opening-closing valve 41, and the second opening-closing valve 42. The operation and stoppage of the fuel gas compressor 24 and an operation of opening and closing the first opening-closing valve 41 and the second opening-closing valve 42 are manually performed by an operator. Therefore, the control device 35 operates the command device 45 when it is necessary to operate and stop the fuel gas compressor 24 and perform the operation of opening and closing the first opening-closing valve 41 and the second opening-closing valve 42.

The command device 45 is, for example, a display device, a speaker, or the like, and command the operation and stoppage of the fuel gas compressor 24 and the operation of opening and closing the first opening-closing valve 41 and the second opening-closing valve 42.

As described above, in the fuel gas supply device of the third embodiment, the command device 45 that issues a command to operate the fuel gas compressor 24 based on the pressure P1 of the fuel gas that is detected by the pressure detector 31 and the pressure detector 32 is provided. Therefore, an operator can easily operate the fuel gas compressor 24 and automatic control becomes unnecessary, which results in cost reduction.

### REFERENCE SIGNS LIST

10: gas turbine
11: compressor
12: combustor
13: turbine
14: rotary shaft
15: generator
20, 20A, 20B: fuel gas supply device
21: fuel gas pressure-reducing station
22: fuel gas purification device
23: pressure-reducing valve (control valve)
24: fuel gas compressor
25: isolation valve
26: fuel gas heating device
27: pressure regulation valve (PCV)
28: flow regulation valve (FCV)
29: check valve
31: pressure detector (second pressure detecting unit)
32: pressure detector (first pressure detecting unit)
33: pressure detector
34: pressure detector
35: control device
41: first opening-closing valve
42: second opening-closing valve
45: command device
100: fuel gas supply source
L1: air intake line
L2: compressed air supply line
L3: fuel gas supply line
L4: combustion gas supply line
L5: exhaust gas discharge line
L11: bypass line (bypass passage)
A: Air
CA: compressed air
F: fuel
CG: combustion gas
EG: exhaust gas

1. A fuel gas supply device comprising:
a fuel gas supply passage that connects a fuel gas supply source and a combustor to each other;
a fuel gas compressor that is provided in the fuel gas supply passage and compresses a fuel gas;
a first pressure detecting unit that detects a pressure of the fuel gas introduced into the fuel gas compressor; and
a control valve that is provided upstream of the fuel gas compressor in the fuel gas supply passage and adjusts the pressure of the fuel gas such that the pressure of the fuel gas that is detected by the first pressure detecting unit reaches a certain target suction pressure, which is a rated discharge pressure of the fuel gas compressor.

2. The fuel gas supply device according to claim 1,
wherein the control valve is a pressure-reducing valve.

3. The fuel gas supply device according to claim 1,
wherein a bypass passage of which one end portion is connected to the fuel gas supply passage that is upstream of the fuel gas compressor and the other end portion is connected to the fuel gas supply passage that is downstream of the fuel gas compressor such that the bypass passage bypasses the fuel gas compressor and a check valve that prevents backflow of the fuel gas in the bypass passage are provided and in a case where the pressure of the fuel gas that is detected by a second pressure detecting unit provided upstream of the control valve is equal to or higher than a pre-set upper limit pressure which is processable by the control valve, supply of the fuel gas to the fuel gas compressor is cut off, operation of the fuel gas compressor is stopped, and the fuel gas is caused to flow through the bypass passage.

4. The fuel gas supply device according to claim 3,
wherein the fuel gas is supplied to the fuel gas compressor and the fuel gas compressor is operated in a case where the pressure of the fuel gas that is detected by the second pressure detecting unit is lower than the upper limit pressure.

5. The fuel gas supply device according to claim 3,
wherein the control valve is disposed between a connecting portion and the fuel gas compressor, the connecting portion being between the fuel gas supply passage and the one end portion of the bypass passage.

6. The fuel gas supply device according to claim 4,
wherein the control valve is disposed upstream of the connecting portion between the fuel gas supply passage and the one end portion of the bypass passage.

7. The fuel gas supply device according to claim 3,
wherein an isolation valve that prevents inflow of the fuel gas from a discharge port of the fuel gas compressor is provided between the fuel gas compressor in the fuel gas supply passage, the fuel gas supply passage, and the other end portion of the bypass passage.

8. The fuel gas supply device according to claim 3, further comprising:
a control device that controls the control valve and the fuel gas compressor based on the pressure of the fuel gas that is detected by the first pressure detecting unit and the second pressure detecting unit.

9. The fuel gas supply device according to claim 3, further comprising:
a command device that issues a command to operate the fuel gas compressor based on the pressure of the fuel gas that is detected by the first pressure detecting unit and the second pressure detecting unit.

10. A fuel gas supply method for a fuel gas supply device including a fuel gas supply passage that connects a fuel gas supply source and a combustor to each other, a fuel gas compressor that compresses a fuel gas flowing through the fuel gas supply passage, and a control valve that is provided upstream of the fuel gas compressor in the fuel gas supply passage, the method comprising:
adjusting a pressure of the fuel gas by means of the control valve such that the pressure of the fuel gas to be introduced into the fuel gas compressor reaches a certain target suction pressure, which is a rated discharge pressure of the fuel gas compressor.
